(19) United States
(12) Patent Application Publication
(10) Pub. No.: US 2016/0371342 A1
(43) Pub. Date: Dec. 22, 2016

(54) ADAPTING SEARCH QUERIES USING A SPECIFIC RESULT

(71) Applicant: Lenovo (Singapore) Pte. Ltd., Singapore (SG)

(72) Inventors: Rod D. Waltermann, Rougemont, NC (US); Hermann Franz Burgmeier, Chapel Hill, NC (US); Jon Wayne Heim, Durham, NC (US)

(21) Appl. No.: 14/744,780

(22) Filed: Jun. 19, 2015

(51) Int. Cl. G06F 17/30

(52) U.S. Cl. CPC G06F 17/30554; G06F 17/30528; G06F 17/30477

(57) ABSTRACT

One embodiment provides a method, including: receiving, at an electronic device, a search query for user files; producing, using a processor, a first result set using the search query; producing, using a processor, an updated search query based on contextual data derived from the first result set; and producing, using a processor, an updated result set based on the updated search query. Other aspects are described and claimed.

### BACKGROUND

Electronic devices (e.g., tablet devices, smart phones, laptop computers, personal computers, etc.) allow users to input searches or queries, e.g., for files such as documents, messages, pictures, audio and video files, etc. These files may be located on the local, user device or may be stored in a remote device or devices, e.g., in a cloud service device or dedicated remote storage device, other user devices, etc.

Search engines or tools allow users to search for almost anything on the local device. The results that such search tools return vary and can include large data sets. If a user wants to refine the results to get a smaller more accurate set, he or she must edit the query and re-submit it. There currently is no mechanism to allow the user to select a set of the results and request more results like those of the set.

### BRIEF SUMMARY

In summary, one aspect provides a method, comprising: receiving, at an electronic device, a search query for user files; producing, using a processor, a first result set using the search query; producing, using a processor, an updated search query based on contextual data derived from the first result set; and producing, using a processor, an updated result set based on the updated search query.

Another aspect provides an electronic device, comprising: an input device; a display device; a processor operatively coupled to the input device and the display device; and a memory that stores instructions executable by the processor to: receive, at the input device, a search query for user files; produce a first result set using the search query; produce an updated search query based on contextual data derived from the first result set; and produce an updated result set based on the updated search query.

A further aspect provides a product, comprising: a storage device that stores code executable by a processor, the code comprising: code that receives a search query for user files; code that produces a first result set using the search query; code that produces an updated search query based on contextual data derived from the first result set; and code that produces an updated result set based on the updated search query.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of electronic device circuitry.

FIG. 2 illustrates another example of electronic device circuitry.

FIG. 3 illustrates an example method of adapting a search query using a specific result.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As described herein, if a user is searching for a file (e.g., document, picture, video, etc.) and issues a search query, today the user must enter one of a few parameters to a search tool. For example, common search parameters include key word(s) included in the file name or file text, date ranges (creation date, modification date, etc.) and location (e.g., particular storage locations). The user is thus bound to enter some of these parameters in order to issue the search. If the result is not what the user wants, the user has no recourse but to modify these same input parameters and try again.

An embodiment employs several interaction mechanisms in order to more closely match the available search parameters to what the user expects to be available for searching his or her files. For example, the user may choose one or more of files included in the original result set as a seed for a subsequent query. This allows the user to run a search for more “results like this.”

In an embodiment, changing or refining of the original query permits production of a subset query that may be applied to the original data set (e.g., applied to the original result set, for example in the case where there are new data elements added to a searched storage location since the original results were produced) or run as a new query (e.g., including additional query parameters or additional search locations). The results then may be returned to the user. Optionally, with each successive “more like this” query, the fuzziness of the search can be increased to allow the result sets to drift further from what the user is asking for (e.g., drift from the initial seed data) and thus increasing the ability to have a broader interpretation of what the user is asking for.

If the user is more specific in the refinement of query parameters, for example asking for results from last week, specifically Tuesday, then an embodiment may add additional parameters to the original query and optionally decrease the fuzziness to further reduce the result set. Moreover, the user may combine these techniques. For example, if a user is asking for pictures from the beach, the initial results may include all beach pictures. The user may then select some pictures that share a common parameter, i.e., they are all from a family reunion. The user may then ask for “more like these,” with an embodiment adding to the query automatically the parameter(s) that associate the indicated files in some way with last years' reunion (e.g., location, time, key word, application or file type, etc.). This results in an updated query that refines the photos to include those from a specific event, but may optionally increase the fuzziness or breadth of the query to include other photos from the same reunion, e.g., not necessarily from the beach.

The illustrated example embodiments will be best understood by reference to the figures. The following description is intended only by way of example, and simply illustrates certain example embodiments.

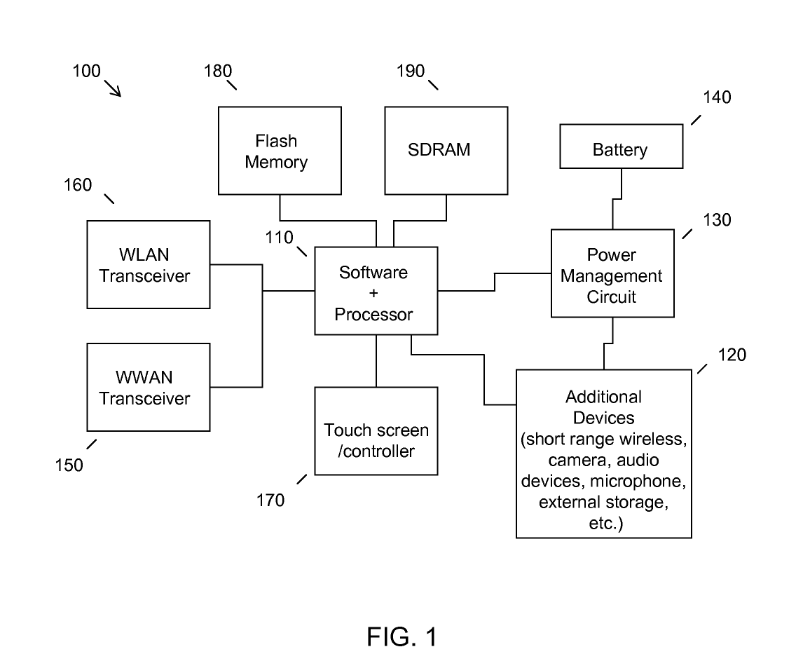

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included. System 100 often includes a touch screen 170 for data input and display/rendering. System 100 also typically includes various memory devices, for example flash memory 180 and SDRAM 190.

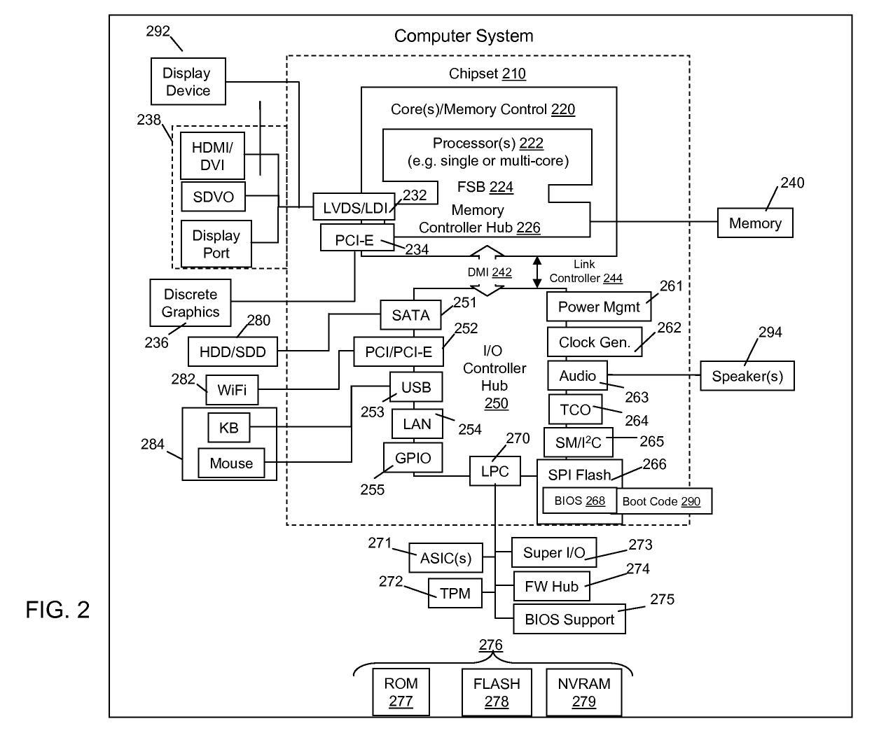

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, laptop or other personal computing devices generally, and/or other electronic devices to which users may interface in order to search for files such as documents, communications/messages, pictures, videos, audio files, etc. An embodiment facilitates production of search results that more closely match what the user is looking for by allowing the user to seed the search process with clues that an embodiment intelligently employs to expand, contract or adapt (e.g., reoder) the result set returned to the user.

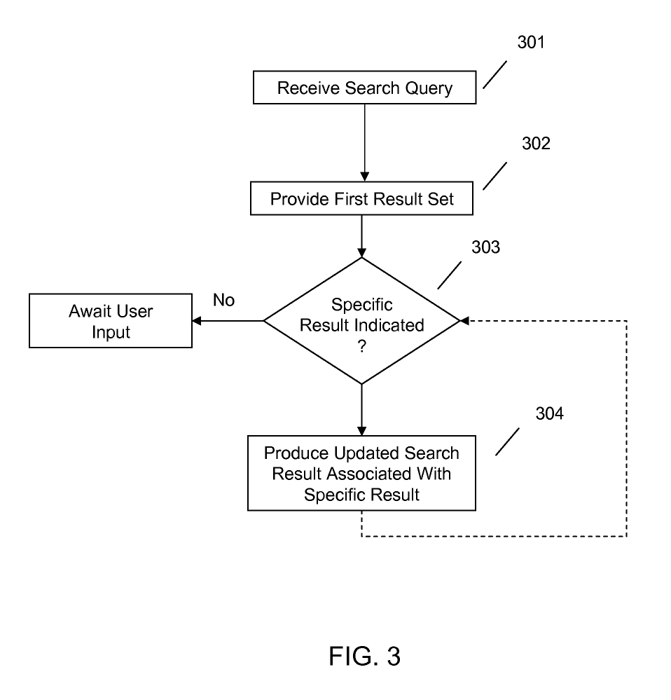

Referring generally to FIG. 3, an embodiment allows a user to adapt a query by leveraging a specific result that appears in current search results. By way of example, a search query for user files may be received at 301, e.g., a user searching for a document, email, picture or the like. The user may input some initial search or query parameters, e.g., key words, a date range, a storage location, etc. An embodiment therefore may produce at 302 a first result set using the search query received at 301.

If a user provides an indication of a specific result in the first result set, as determined at 303, an embodiment may use this specific result to expand, contract or otherwise adapt the search, as further described herein. For example, an embodiment may determine at 303 that a user has indicated a specific result, e.g., clicked on a particular result, touched a particular result, provided voice input regarding a particular result, etc. An embodiment may use this as a cue that this result is of particular interest to the user and conclude that it may be used as a seed or starting point for further searching, refined searching, re-ordering of search results and the like. As is apparent, if no specific result is indicated, as determined at 303, an embodiment may await a user input.

However, if a result is indicated, i.e., an updated search query associated with the first search query is received, such as a user providing input that he or she wishes to see more “results like this” in connection with a specific result, an embodiment may produce an updated search result using the specific result in an updated query. It is worth noting that “a specific result” may be a group of results, i.e., the term “a” is used here, but there may be more than one specific result indicated. An embodiment uses the specific result indicated as a starting point for generating an updated query and producing an updated result set based on the updated search query. As described herein, the updated result set may be an expanded result set, a sub-set, a refined or adapted result set, as compared with the first result set, depending on the processing applied.

By way of example, an embodiment may use the specific result set as a seed or starting point to identify contextual data for use in the updated search query. The contextual data may include contextual or other meta data associated with the specific result in the first result set. As a specific, non-limiting example, the contextual data may include time data, location data, application data, state data (e.g., an application is in presentation mode, edit mode, etc.), contact or user data, calendar data, communication data (e.g., email data, etc.), and event data (e.g., user initiated events such as open, save, input events provided via a mouse or touch screen, etc.). Thus, if a user indicates a beach picture having a geo tag with a particular location as the specific result in the first result set, the contextual meta data may include the location associated with the geo tag.

Having obtained this meta data based on the specific result indicated, an embodiment may search for and match meta data contained in a contextual data store. For example, an embodiment may search using the location of the geo tag for meta data (and thus files) having the same or similar geo tag location. These geo tags and/or files may be included in a contextual data store. The contextual data store may be consolidated (e.g., maintained in the cloud in association with the user and/or his or her devices) or distributed, e.g., contextual tags may be stored with the files in various storage locations.

Thus, producing an updated result set based on the updated search query at 304 may include matching one or more meta data elements of the specific result to one or more meta data elements in the contextual data store. As may be appreciated, this may facilitate the location of additional files not included in the original, first result set because the geo tag location may not have been included in the initial search query input by the user. Likewise, the updated search result produced at 304 may be a refinement or sub-set of the first result set, e.g., with files sharing the geo tag location being promoted higher in the updated result set. That is, the updated result set may be a sub-set of the first result set, may be an expanded result set, or may be a re-ordered result set, as compared to the first result set.

As will be appreciated from the foregoing, the use of a result in the first result set facilitates the location of files that may not be contained within the first result set or that may be lower—ranked in the first result set. The process makes selection of search parameters much easier on the user, as the user need only indicate which result(s) are particularly interesting and automated processing completes the task of updating the search. Thus, the user need not know of a particular geo tag (or other meta data) in order to make use of the same in a refined or updated search.

As may be understood by those of ordinary skill in the art, the process may be repeated as desired (i.e., another specific result may be selected from an updated result set such that the process iterates—as indicated by the dashed line in FIG. 3). Over time, this iterative processing can lead to an expansive searching that nonetheless returns increasingly targeted results (i.e., as contextual meta data is added to the search query). Likewise, an embodiment may provide the user an opportunity to add or remove contextual meta data from the search, e.g., by displaying the contextual meta data tags available to be used and/or actually used to produce a result or a set of results. This permits the user to become more involved with the query processing, should the user desire to do so.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an electronic device, a search query for user files;
producing, using a processor, a first result set using the search query;
producing, using a processor, an updated search query based on contextual data derived from the first result set; and
producing, using a processor, an updated result set based on the updated search query.

2. The method of claim 1, wherein the updated search query is associated with a specific result in the first result set.

3. The method of claim 2, further comprising using the specific result in the first result set to identify the contextual data for use in the updated search query.

4. The method of claim 1, wherein the contextual data comprises contextual meta data stored in a remote location.

5. The method of claim 1, wherein the contextual data is selected from the group consisting of time data, location data, application data, state data, user data, communication data, and event data.

6. The method of claim 3, wherein the using the specific result in the first result set to identify contextual data for use in the updated search query comprises matching meta data associated with the specific result with meta data in a contextual data store.

7. The method of claim 6, wherein the producing an updated result set based on the updated search query comprises matching one or more meta data elements of the specific result to one or more meta data elements in the contextual data store.

8. The method of claim 1, wherein the updated result set is a sub-set of the first result set.

9. The method of claim 1, wherein the update result set is an expanded result set compared to the first result set.

10. The method of claim 9, wherein the expanded result set is produced by automatically adding a data parameter to the updated search query.

11. An electronic device, comprising:
an input device;
a display device;
a processor operatively coupled to the input device and the display device; and
a memory that stores instructions executable by the processor to:
receive, at the input device, a search query for user files;
produce a first result set using the search query;
produce an updated search query based on contextual data derived from the first result set; and
produce an updated result set based on the updated search query.

12. The electronic device of claim 11, wherein the updated search query is associated with a specific result in the first result set.

13. The electronic device of claim 2, wherein the instructions are further executable by the processor to use the specific result in the first result set to identify the contextual data for use in the updated search query.

14. The electronic device of claim 11, wherein the contextual data comprises contextual meta data stored in a remote location.

15. The electronic device of claim 11, wherein the contextual data is selected from the group consisting of time data, location data, application data, state data, user data, communication data, and event data.

16. The electronic device of claim 13, wherein to use the specific result in the first result set to identify contextual data for use in the updated search query comprises matching meta data associated with the specific result with meta data in a contextual data store.

17. The electronic device of claim 16, wherein to produce an updated result set based on the updated search query comprises matching one or more meta data elements of the specific result to one or more meta data elements in the contextual data store.

18. The electronic device of claim 11, wherein the updated result set is a sub-set of the first result set.

19. The electronic device of claim 11, wherein the update result set is an expanded result set compared to the first result set.

20. A product, comprising:
a storage device that stores code executable by a processor, the code comprising:
code that receives a search query for user files;
code that produces a first result set using the search query;
code that produces an updated search query based on contextual data derived from the first result set; and
code that produces an updated result set based on the updated search query.
